(19) United States
(12) Patent Application Publication
(10) Pub. No.: US 2014/0161263 A1
(43) Pub. Date: Jun. 12, 2014

(54) FACILITATING RECOGNITION OF REAL-TIME CONTENT

(71) Applicant: MICROSOFT CORPORATION, Redmond, WA (US)

(72) Inventors: KAZUHITO KOISHIDA, REDMOND, WA (US); THOMAS C. BUTCHER, SEATTLE, WA (US); IAN STUART SIMON, SAN FRANCISCO, CA (US)

(73) Assignee: MICROSOFT CORPORATION, REDMOND, WA (US)

(21) Appl. No.: 13/709,816

(22) Filed: Dec. 10, 2012

(51) Int. Cl. G01H 3/00

(52) U.S. Cl. CPC G01H 3/00
USPC 381/56

(57) ABSTRACT

Systems, methods, and computer-readable storage media for facilitating recognition of real-time content are provided. In embodiments, a new audio fingerprint associated with live audio being presented is received. In accordance with the received audio fingerprint, at least one previously received fingerprint associated with the live audio from a real-time index is removed. Thereafter, the real-time index is updated to include the new audio fingerprint associated with the live audio being presented. Such a real-time index having the new audio fingerprint can be used to recognize the live audio being presented and, thereafter, an indication of the recognized live audio can be provided to the user device.

### BACKGROUND

Music recognition programs traditionally operate by capturing audio data using device microphones and submitting queries to a server that includes a searchable database. The server is then able to search its database, using the audio data, for information associated with content from which the audio data was captured. Such information can then be returned for consumption by the device that sent the query.

Generally, audio content, such as music content, is fingerprinted and indexed in an offline mode to generate or update a searchable database. Utilizing offline fingerprinting and indexing, however, prevents real-time recognition of live audio content. For example, live audio content, such as TV and radio, may not be recognized by a user device in real-time as fingerprint data of such live content is not readily accessible via a searchable database in real-time.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-readable storage media for, among other things, recognizing real-time content. In this regard, live content (e.g., TV and radio) can be recognized in real-time. Various embodiments enable live audio, such as music content, to be fingerprinted and indexed in real-time thereby permitting live audio to be recognized in real-time. In some embodiments, to generate an index in real-time, upon receiving a new fingerprint associated with live audio, at least one previously received fingerprint is removed from the real-time index and the real-time index is updated to include the new fingerprint.

### BRIEF DESCRIPTION OF THE DRAWINGS

The present invention is illustrated by way of example and not limited in the accompanying figures in which:

FIG. 1 is a block diagram of an exemplary computing environment suitable for use in implementing embodiments of the present invention;

FIG. 2 is a block diagram of an exemplary computing system in which embodiments of the invention may be employed;

FIG. 3 is a flow diagram showing an exemplary method associated with capturing live audio in real-time, in accordance with an embodiment of the present invention;

FIG. 4 is a flow diagram showing an exemplary first method associated with generating fingerprints in real-time, in accordance with an embodiment of the present invention;

FIG. 5 is a flow diagram showing an exemplary second method associated with generating fingerprints real-time, in accordance with an embodiment of the present invention;

FIG. 6 is a flow diagram showing an exemplary first method for producing a real-time index, in accordance with an embodiment of the present invention;

FIG. 7 is a flow diagram showing an exemplary second method for producing a real-time index, in accordance with an embodiment of the present invention;

FIG. 8 is a flow diagram showing an exemplary first method for recognizing live audio in real-time, in accordance with an embodiment of the present invention; and

FIG. 9 is a flow diagram showing an exemplary second method for recognizing live audio in real-time, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable storage media for, among other things, recognizing real-time content. In this regard, live content (e.g., TV and radio) can be recognized in real-time. Various embodiments enable live audio, such as music content, to be fingerprinted and indexed in real-time thereby permitting live audio to be recognized in real-time. In some embodiments, to generate an index in real-time, upon receiving a new fingerprint associated with live audio, at least one previously received fingerprint is removed from the real-time index and the real-time index is updated to include the new fingerprint.

Accordingly, one embodiment of the present invention is directed to one or more computer-readable storage media storing computer-useable instructions that, when used by one or more computing devices, cause the one or more computing devices to perform a method for facilitating recognition of real-time content. The method includes receiving a new audio fingerprint associated with live audio being presented. Thereafter, at least one previously received fingerprint associated with the live audio from a real-time index is removed. The real-time index is updated to include the new audio fingerprint associated with the live audio being presented. As such, the real-time index having the new audio fingerprint can be used to recognize the live audio being presented.

Another embodiment of the present invention is directed to a system for facilitating recognition of real-time content. The system includes a real-time index builder configured to generate an index in real-time using one or more audio fingerprints generated in real-time from live audio content. The system also includes an audio content recognizer configured to receive, from a user device, an audio fingerprint generated based on the live audio content. The audio content recognizer utilizes the real-time index builder to recognize the live audio content.

In yet another embodiment, the present invention is directed to one or more computer-readable storage media storing computer-useable instructions that, when used by one or more computing devices, cause the one or more computing devices to perform a method for facilitating recognition of real-time content. The method includes generating, using a user device, a fingerprint based on live audio being provided by a live audio source. The fingerprint is provided to an audio recognition service having a real-time index that is updated in real-time to include a fingerprint(s) corresponding with the live audio, wherein the fingerprint(s) were generated in real-time by a component remote from the user device. Displayable content information is received from the audio recognition service based on a comparison of the user-device generated fingerprint and the fingerprint(s) generated in real-time by the component remote from the user device. Thereafter, display of the displayable content information is caused.

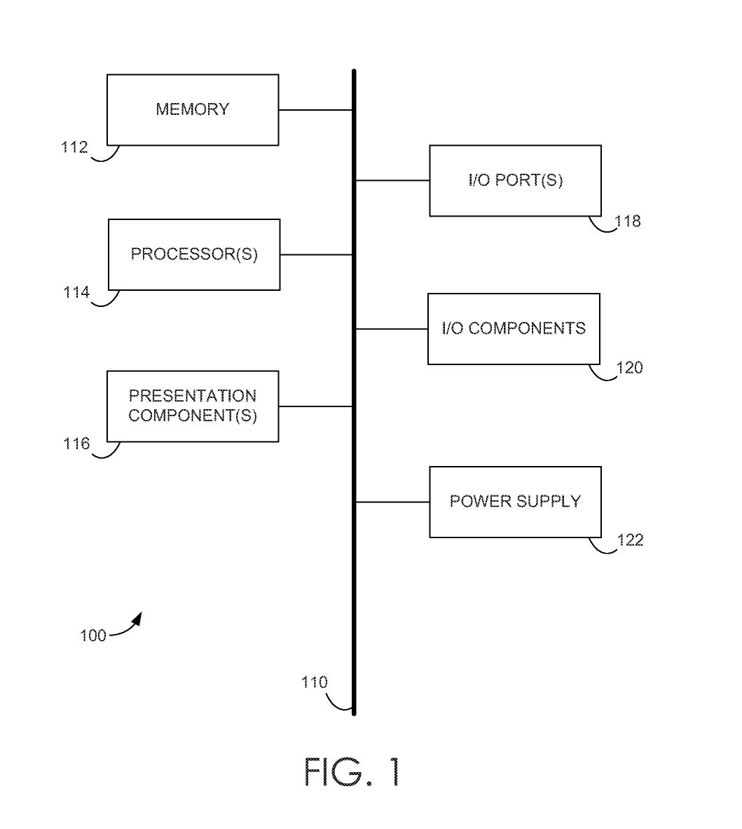

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules including routines, programs, objects, components, data structures, and the like, refer to code that performs particular tasks or implements particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, input/output (I/O) ports 118, I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media. Computer storage media includes volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, and the like.

As previously mentioned, embodiments of the present invention relate to systems, methods, and computer-readable storage media for, among other things, facilitating recognition of real-time content. In this regard, real-time content or live content (e.g., TV, radio, and web content) can be recognized as it is being presented live or in real-time. Real-time content and live content (e.g., such as audio and/or video) may be used interchangeably herein. To recognize live content, various embodiments of the invention enable live content, such as music content, to be fingerprinted and indexed in real-time such that the live content can be recognized in real-time. Real-time content or live content refers to content, such as music, that is played or presented in real-time or live. In this regard, as live content is being presented, audio fingerprints for such content can be generated and indexed in real-time so that content recognition can occur in real-time. As audio fingerprints are indexed in real-time, a user device capturing the live content can utilize the real-time index to recognize live content in real-time.

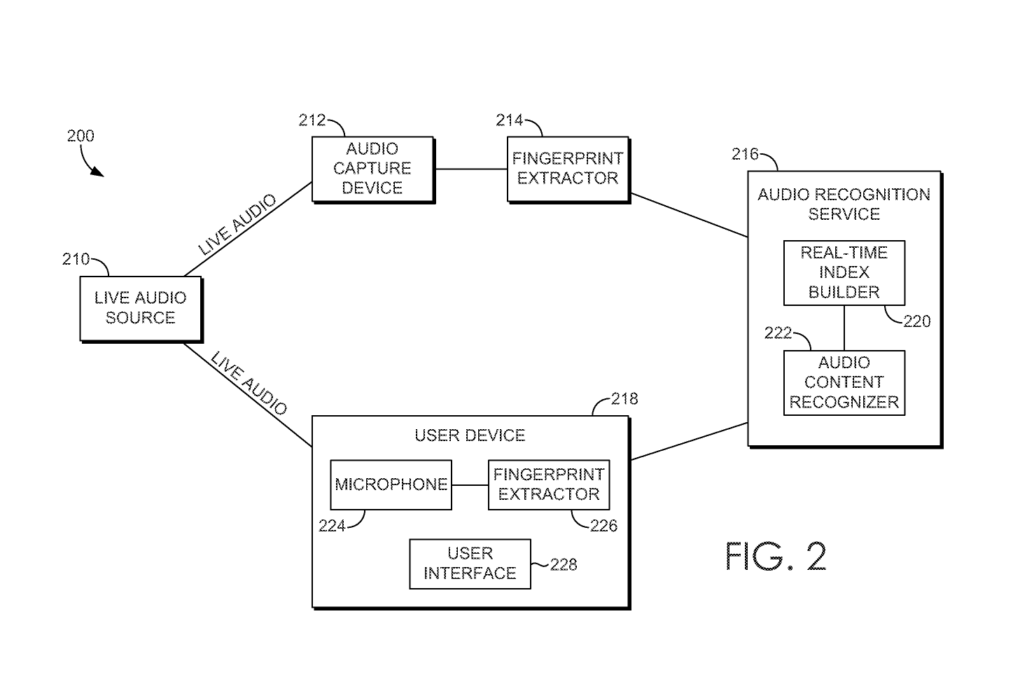

Referring now to FIG. 2, a block diagram is provided illustrating an exemplary computing system 200 in which embodiments of the present invention may be employed. Generally, the computing system 200 illustrates an environment in which live audio can be recognized in real-time. Among other components not shown, the computing system 200 generally includes a live audio source 210, an audio capture device 212, a fingerprint extractor 214, an audio recognition service 216, and a user device 218. One or more of these components can be in communication with one another via a network(s) (not shown). Such a network(s) may include, without limitation, one or more local area networks (LANs) and/or wide area networks (WANs). Such networking environments are commonplace in offices, enterprise-wide computer networks, intranets and the Internet.

It should be understood that any number of live audio sources, audio capture devices, fingerprint extractors, audio recognition services, and user devices may be employed in the computing system 200 within the scope of embodiments of the present invention. Each may comprise a single device/interface or multiple devices/interfaces cooperating in a distributed environment. For instance, the audio recognition service 216 may comprise multiple devices and/or modules arranged in a distributed environment that collectively provide the functionality of the audio recognition service 216 described herein. Additionally, other components/modules not shown also may be included within the computing system 200.

In some embodiments, one or more of the illustrated components/modules may be implemented as stand-alone applications. In other embodiments, one or more of the illustrated components/modules may be implemented via an operating system or integrated with an application running on a device. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of computing devices. By way of example only, the audio recognition service 216 might be provided as a single server, a cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

In operation, live audio is presented via a live audio source 210. Live audio refers to any live content having an audio portion. Live audio may be, but is not limited to, live television audio, live radio audio, live event audio (e.g., live music concert), live streaming media, live web broadcast, or the like. By way of example, live audio might be a live presentation that is presented in real-time in association with a live event (e.g., an emergency weather report being presented live or a sporting event being presented live or in real-time) or a pre-programmed presentation (e.g., a weather report recorded in advance of being presented). In some embodiments, a live audio is an audio presented in real-time for which an audio fingerprint is generated in real-time. That is, prior to the live audio, a corresponding audio fingerprint(s) does not exist for content recognition.

In some embodiments, the live audio source 210 is a device, such as a set-top box, a television, a radio, a live streaming source, or other computing device that provides live audio (e.g., web broadcasts or local broadcasts). For example, live audio may be presented by a device in association with a broadcast channel (e.g., local broadcast channel) or a live streaming source, such as a FM or HD radio signal stream. In other embodiments, a live audio source 210 refers to an individual or group of individuals, such as at a music concert or other live presentation, that present live audio.

The audio capture device 212 is configured to capture live audio data associated with the live audio. Live audio data can be captured in any suitable manner and utilize any type of technology. Examples provided herein are not intended to limit the scope of embodiments of the present invention. The audio capture device 212 can be any computing device capable of capturing, in real-time, live audio data associated with live audio provided by a live audio source, such as live audio source 210. In some embodiments, the audio capture device 212 might be a server or other computing device associated with or connected with a live audio source(s). For instance, the audio capture device 212 might reside at a live streaming source, a broadcast channel, a radio station, a television channel, a web broadcast source, etc. In this way, a first audio capture device can be located in association with a first live audio source (e.g., a first radio station), and a second audio capture device can be located in association with a second live audio source (e.g., a second radio station) that is different from the first live audio source. In other embodiments, the audio capture device 212 might be remote or separate from a live audio source. For example, the audio capture device 212 may be centrally located or be a user device, such as a set-top box, a mobile device, or other user device that can capture live audio presented via a live audio source, such as live audio source 210.

In operation, the audio capture device 212 receives and captures live audio data. Such live audio data can be stored in a data store, such as a database, memory, or a buffer. This can be performed in any suitable way and can utilize any suitable database, buffer, and/or buffering techniques. For instance, audio data can be continually added to a buffer, replacing previously stored audio data according to buffer capacity. By way of example, the buffer may store the last minute of audio, last five minutes of audio, last ten minutes, depending on the specific buffer used and device capabilities.

The audio capture device 212 provides audio data to the fingerprint extractor 214. In this regard, the audio capture device 212 may transmit audio data to the fingerprint extractor 214, or the fingerprint extractor 214 may retrieve audio data from the audio capture device 212. The audio capture device 212 provides audio data in real-time to the fingerprint extractor 214. In this way, upon capturing audio data, the audio capture device 212 can immediately provide the audio data to the fingerprint extractor 214 for processing the data.

In embodiments, the audio capture device 212 provides audio data in the form of audio samples. An audio sample refers to a portion, segment, or block of audio data that can correspond with a number of frames or a time duration of audio (i.e., an audio sample size). Audio samples can be any suitable size of audio data. As can be appreciated, an audio sample size may be a single frame or a plurality of sequential frames. Alternatively or additionally, an audio sample size may be audio data associated with a time duration, such as a predetermined time duration of one second of audio (or any other amount of time).

The fingerprint extractor 214 generates, computes, or extracts, in real-time, fingerprints associated with live audio. In embodiments, the fingerprints are associated with a fingerprint size, such as a predetermined number of frames, frame rate (e.g., frames per second), time duration, bits per second, or the like. In one implementation, such a fingerprint size may be substantially similar to or the same as the audio sample size of audio samples received from the audio capture device 212. In such a case, the fingerprint extractor 214 processes audio data in the form of audio samples received from the audio capture device 212 at which the audio data is captured. In another implementation, a fingerprint size may be based on a set of audio samples received from the audio capture device. In this regard, an audio fingerprint can be generated based on a plurality of received audio samples, as described in more detail below. Any suitable quantity of audio samples can be processed. Processing one or more audio samples to generate a corresponding fingerprint is not intended to limit the scope of embodiments of the present invention. Rather, portions of audio samples or audio data can be processed to generate fingerprints.

An audio fingerprint refers to a perceptual indication of a piece or portion of audio content. In this regard, an audio fingerprint is a unique representation (e.g., digital representation) of audio characteristics of audio in a format that can be compared and matched to other audio fingerprints. As such, an audio fingerprint can identify a fragment or portion of audio content. In embodiments, an audio fingerprint is extracted, generated, or computed from an audio sample or set of audio samples, where the fingerprint contains information that is characteristic of the content in the sample.

Various implementations can be used to achieve a desired complexity and/or latency for generating fingerprints and/or a real-time index. For example, a progressive indexing implementation, as described more fully below, can be used to reduce the computational complexity of the index update. A swap indexing implementation, as described more fully below, can be used to minimize the duration of index unavailability, for example, due to a programming lock. Further, a combination of such approaches can be used to optimize desired performance (e.g., complexity and/or latency).

In a progressive indexing implementation, the fingerprint extractor 214 generates or computes a fingerprint associated with a new audio sample(s). In this regard, the fingerprint extractor 214 produces a fingerprint only from a given new audio sample(s) for which a fingerprint has not previously been generated. Such an implementation can facilitate avoiding information overlap among fingerprints. In a progressive indexing implementation, the fingerprint size can correspond with a received audio sample size (e.g., associated with one second of audio content).

By way of example only, assume the fingerprint extractor 214 receives audio samples having audio data associated with one second of audio content. For a newly received audio sample, the fingerprint extractor 214 can, in real-time, generate a fingerprint that corresponds with one second of audio data. That is, a fingerprint size corresponds with one second of audio data. Continuing with this example, as the fingerprint extractor 214 receives an audio sample approximately every second and generates a fingerprint in real-time, the fingerprint extractor 214 can create a fingerprint approximately every second and immediately transmit the generated fingerprint to the real-time index builder 220 of the audio recognition service 216. In this regard, the fingerprint extractor 214 can upload the latest fingerprint at real-time intervals to the real-time index builder 220.

In a swap indexing implementation, the fingerprint extractor 214 generates or computes a fingerprint using new and previous audio samples and/or audio fingerprints. In this regard, in some embodiments, upon receiving audio samples, the audio samples are collected or stored within the fingerprint extractor 214, for instance, via a buffer or other data store, such that fingerprints can be generated using new and previously received audio samples. In other embodiments, previously computed audio fingerprints can be collected or stored within the fingerprint extractor 214 (or other accessible component), for instance, via a buffer or other data store, such that a new fingerprint can be generated using the previously computed fingerprints along with a fingerprint generated from a recently received audio sample(s). In some embodiments, a fingerprint can be generated upon an occurrence of a predetermined event (e.g., a lapse of a time duration, a collection of an amount of data or time associated with audio data, or the like). For example, upon the lapse of a time duration, such as one second, a fingerprint can be generated based on any amount of new and previous audio samples.

In one embodiment, a fingerprint is generated based on all data stored within a buffer or other data store associated with the fingerprint extractor 214. For instance, assume a buffer is designed to contain sixty seconds of audio samples each associated with one second of data. In such a case, the fingerprint can be generated based on the sixty seconds of audio samples resulting in a fingerprint associated with sixty seconds of audio data. In another embodiment, the fingerprint is generated based on a predetermined fingerprint size (e.g., an amount of audio data, a frame rate, etc.). For instance, assume that a fingerprint is desired to be generated in association with sixty seconds of audio data. Further assume that received audio samples are associated with one second of data. In this regard, the fingerprint extractor 214 can use the sixty most recently received audio samples to attain a fingerprint associated with sixty seconds of audio data. Accordingly, the fingerprint extractor 214 can create a fingerprint upon the lapse of a time duration (e.g., one second) using new and previously received audio samples and then immediately transmit the fingerprint to the real-time index builder 220 of the audio recognition service 216. As such, a fingerprint corresponding with one minute of audio data can be generated and transmitted every second or in accordance with another interval.

Generating or extracting fingerprints can be performed in any number of ways. Any suitable type or variation of fingerprint extraction can be performed without departing from the spirit and scope of embodiments of the present invention. Generally, to generate or extract a fingerprint, audio features or characteristics are computed and used to generate the fingerprint. Any suitable type of feature extraction or computation can be performed without departing from the spirit and scope of embodiments of the present invention. Audio features may be, by way of example and not limitation, genre, beats per minute, mood, audio flatness, Mel-Frequency Cepstrum Coefficients (MFCC), Spectral Flatness Measure (SFM) (i.e., an estimation of the tone-like or noise-like quality), prominent tones (i.e., peaks with significant amplitude), rhythm, energies, modulation frequency, spectral peaks, harmonicity, bandwidth, loudness, average zero crossing rate, average spectrum, or other features that represent a piece of audio content.

As can be appreciated, various pre-processing and post-processing functions can be performed prior to and following computation of one or more audio features that are used to generate an audio fingerprint. For instance, prior to computing audio features, audio samples may be segmented into frames or sets of frames with one or more audio features computed for every frame or sets of frames. Upon obtaining audio features, such features (e.g., features associated with a frame or set of frames) can be aggregated (e.g., with sequential frames or sets of frames). In this regard, an audio sample can be converted into a sequence of relevant features. In embodiments, a fingerprint can be represented in any manner, such as, for example, a feature(s), an aggregation of features, a sequence of features (e.g., a vector, a trace of vectors, a trajectory, a codebook, a sequence of indexes to HMM sound classes, a sequence of error correcting words or attributes, etc.). By way of example, a fingerprint can be represented as a vector of real numbers or as bit-strings.

Upon generating, extracting, or computing fingerprints, the fingerprint extractor 214 provides the fingerprints to the real-time index builder 220 of the audio recognition service 216 in real-time. That is, in accordance with generation of a fingerprint, such a fingerprint is transmitted to the real-time index builder 220, or retrieved by the real-time index builder 220, for processing by the audio recognition service 216.

The audio recognition service 216 is configured to facilitate real-time audio recognition of live content. In this regard, as live content is being presented, the audio recognition service 216 can index the live content in real-time to enable the live content to be recognized. Accordingly, a user device, such as user device 218, capturing the live content can be provided with an indication of the live content or an executable action associated with the live content in real-time. In embodiments, the audio recognition service 216 may be remote from the fingerprint extractor 214 and/or the user device 218. In such embodiments, the fingerprint extractor 214 and/or the user device 218 can communicate with the audio recognition service 216 via one or more networks (not shown). Such a network(s) may include, without limitation, one or more local area networks (LANs) and/or wide area networks (WANs). Such networking environments are commonplace in offices, enterprise-wide computer networks, intranets and the Internet.

The real-time index builder 220 of the audio recognition service 216 is configured to build or generate an index in real-time. In this regard, an index can be newly developed or modified in real-time for use in recognizing live audio content. The real-time index builder 220 uses fingerprints provided by a fingerprint extractor(s), such as fingerprint extractor 214, to generate an index in real-time (i.e., a real-time index).

A real-time index refers to an index produced in real-time that enables live content to be recognized. A real-time index can be a structure that allows efficient answering of queries regarding live audio content. In embodiments, the real-time index efficiently assembles fingerprints, or data associated therewith, such that live content can be readily recognized. A real-time index and/or corresponding data store may be used to store any amount of information. In some embodiments, the real-time index and/or corresponding data store is intended only for use in identifying live content in real-time. In such an embodiment, the data stored in the index and/or data store may be limited such that only fingerprints and/or corresponding data associated with a most recent predetermined time duration are included therein. For example, fingerprint data associated with the most recent three minute time interval might be included in the index and data store.

In a progressive indexing implementation, the real-time index builder 220 receives a fingerprint associated with a new audio sample(s). In this regard, the real-time index builder 220 receives a fingerprint associated with a given new audio sample(s) for which a fingerprint has not previously been generated and/or indexed. The real-time index builder 220 progressively updates the index with the most recently received fingerprint. In cases that a limited amount of fingerprint data is desired or required in the index and/or data store, in accordance with adding a most recently received fingerprint, an oldest fingerprint (or earliest received fingerprint) can be discarded such that it is not included in the modified index. By way of example only, assume the real-time index builder 220 includes a queue sized to include fingerprints associated with one minute of audio content. When a new fingerprint associated with a most recent second of live audio is received, the oldest fingerprint associated with the earliest received audio second is deleted. The index is then generated or modified based on the current fingerprints associated with the most recent minute of audio content.

In a swap indexing implementation, the real-time index builder 220 receives a fingerprint associated with new and previous audio samples. In this regard, the real-time index builder 220 can update the index and/or data store by using the most recently received fingerprint and discarding the previously received fingerprint. As such, upon reception of a new fingerprint, the real-time index builder 220 can discard the previously received fingerprint data and entirely replace the previously received fingerprint with the newly received fingerprint data. The newly received fingerprint data can then be used to generate or modify the index and/or corresponding data store. By way of example only, assume the real-time index builder 220 contains a first fingerprint associated with a first sixty seconds of audio content. Now assume that the real-time index builder 220 receives a second fingerprint associated with a second sixty seconds of audio content (e.g., having fifty nine seconds of overlap with the first sixty seconds of audio content). Upon receiving the second fingerprint, the first fingerprint is deleted, and the index is generated in real-time based on the second fingerprint.

As the real-time index builder 220 builds or generates an index in real-time, the audio content recognizer 222 can access the data and identify live content in real-time. In operation, the audio content recognizer 222 receives fingerprints from one or more user devices, such as user device 218. The user device 218 may include any type of computing device, such as the computing device 100 described with reference to FIG. 1, for example. In embodiments, the user device is a mobile device, such as a laptop, a tablet, a netbook, a mobile phone, a portable music player, a personal digital assistant, a dedicated messaging device, a portable game device, or the like. Generally, the user device 218 includes a microphone 224, a fingerprint extractor 226, and a user interface 228.

In implementation, the user device 218 captures live audio data, for instance, provided by the live audio source 210. This can be performed in any suitable way. For example, the audio data can be captured from a streaming source, such as an FM or HD radio signal stream. The microphone 224 is representative of functionality used to capture audio data for provision to the audio recognition service 216. Such data can be stored, for example, in a buffer. In one or more embodiments, when user input is received indicating that audio data capture is desired, the captured audio data can be processed. In particular, the fingerprint extractor 226 can extract or generate one or more fingerprints associated with live audio data captured via the microphone 224. As with the fingerprint extractor 214, the fingerprint extractor 226 of the user device 218 can operate in any manner and the method used for extracting fingerprints is not intended to limit the scope of embodiments of the present invention. The extracted or generated fingerprint(s) can then be transmitted, for instance, as a query over a network, to the audio content recognizer 222 of the audio recognition service 216.

In one embodiment, the fingerprint extractor 226 may operate upon receiving a user indication to identify content. For example, the user may be at a live concert and hear a particular song of interest. Responsive to hearing the song, the user can launch, or execute, an audio recognition capable application and provide input via an “Identify Content” instrumentality that is presented on the user device via the user interface 228. Such input indicates to the user device that audio data capture is desired and that additional information associated with the audio data is to be requested. The fingerprint extractor 226 can then extract a fingerprint(s) from the captured audio data and generate a query packet that can be sent to the audio recognition service 216 including the fingerprint.

In another embodiment, a fingerprint extractor 226 may operate automatically. For example, the user may be at a live concert. Responsive to capturing audio content, the fingerprint extractor 226 may automatically extract a fingerprint(s) from the captured audio data and generate a query packet that can be sent to the audio recognition service 216 including the fingerprint.

Upon receiving a fingerprint from a user device, for example via a network (not shown), the audio content recognizer 222 can access a real-time index and/or corresponding data store generated by the real-time index builder 220 to identify or detect a fingerprint match between a fingerprint received from a user device and a fingerprint within the real-time index and/or corresponding data store. In this regard, the audio content recognizer 222 can search or initiate a search of the index to identify fingerprint data, or a portion thereof, that matches or substantially matches (e.g., exceeds a predetermined similarity threshold) fingerprint data received from a user device.

The audio content recognizer 222 can utilize an algorithm to search an index of fingerprints, or data thereof, to find a match or substantial match. Any suitable type of searchable information can be used. For example, searchable information may include fingerprints or data associated therewith, such as spectral peak information associated with a number of different songs. In one particular implementation, peak information (indexes of time/frequency locations) for each live content can be sorted by a frequency index. A best matched live content can be identified by a linear scan, beam searching, or hash function of the fingerprint index.

Upon detecting a matching fingerprint, a substantially matching fingerprint, or a best-matched fingerprint, content information associated with such a fingerprint can be obtained (e.g., looked-up or retrieved). Such content information can include, by way of example and not limitation, displayable information such as a song title, an artist, an album title, lyrics, a date the audio clip was performed, a writer, a producer, a group member(s), and/or other information describing or indicating the content. In other embodiments, content information may include an advertisement that corresponds with the content represented by the fingerprint. In yet other embodiments, content information may be an executable item that can be provided to the user device to initiate execution of an action on the user device, such as opening a website or application on the user device. For example, upon recognizing a fingerprint associated with a particular artist, an indication of an action to open the artist's web page can be provided to the user device 218. The content information can then be returned to the user device 218 so that it can be presented, for example, to a user or otherwise implemented (e.g., initiation of an action). Other information can be returned without departing from the spirit and scope of the claimed subject matter.

The user device 218 can identify when it has received displayable information or an executable item from the audio recognition service 216. This can be performed in any suitable way. In such a case, the user device 218 can cause a representation of the displayable content information to be displayed or cause initiation and/or execution of the executable action. The representation of the content information to be displayed can be album art (such as an image of the album cover), an icon, text, an advertisement, a coupon, a link, etc. Execution of an executable action can result in opening or presentation of a website, an application, an alert, an audio, or the like.

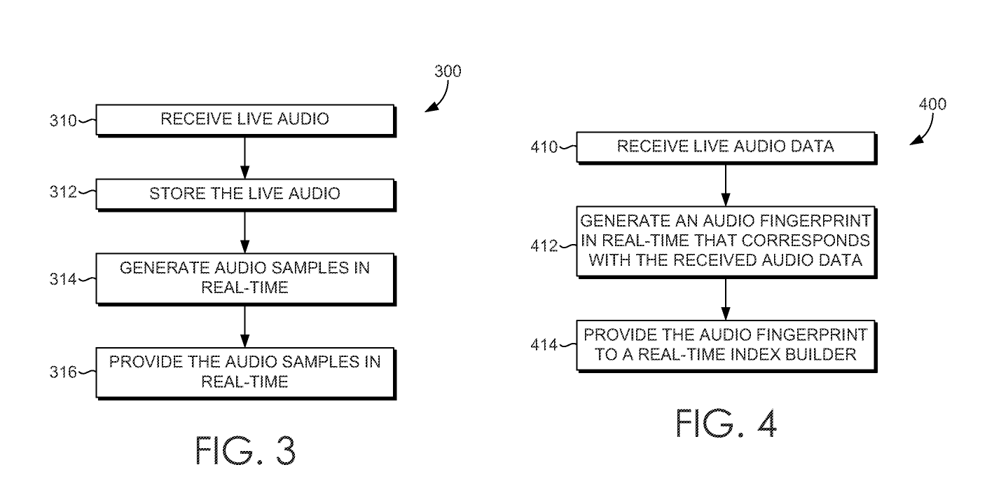

With reference to FIG. 3, a flow diagram is provided that illustrates an exemplary method 300 for facilitating recognition of real-time content, in accordance with an embodiment of the present invention. Such a process may be performed, for example, by an audio capture device, such as the audio capture device 212 of FIG. 2. Initially, as indicated at block 310, live audio is received. Such live audio can be provided, for example, by any live audio provider, such as a radio station, a television station, a web content provider, or the like. At block 312, live audio data is stored, for example, via a buffer. Audio samples are generated in real-time, as indicated at block 314. Audio samples can be any suitable size of audio data. In this regard, an audio sample can be any portion, segment, or block of audio data that corresponds with a number of frames or a time duration of audio (i.e., an audio sample size). At block 316, the audio samples are provided in real-time, for instance, to a fingerprint extractor.

With reference to FIG. 4, a flow diagram is provided that illustrates an exemplary method 400 for facilitating recognition of real-time content, in accordance with an embodiment of the present invention. Such a process may be performed, for example, by a fingerprint extractor, such as the fingerprint extractor 214 of FIG. 2, implementing a progressive indexing method. Initially, as indicated at block 410, live audio data is received. Such live audio data might be in the form of an audio sample. At block 412, an audio fingerprint is generated in real-time that corresponds with the received audio data. In this regard, the fingerprint is produced from only the newly received audio data. At block 414, in real-time, the fingerprint is provided to a real-time index builder.

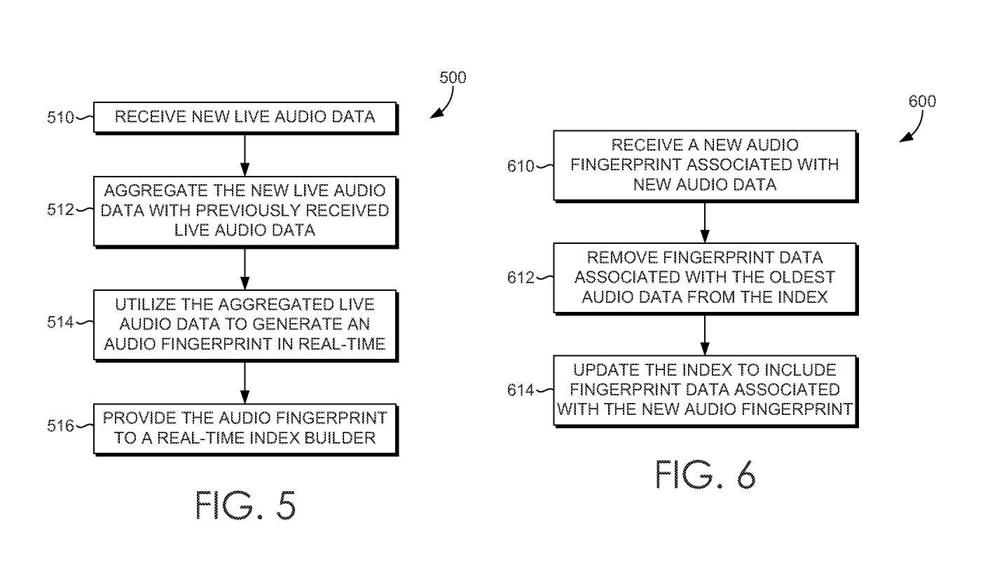

Turning to FIG. 5, a flow diagram is provided that illustrates an exemplary method 500 for facilitating recognition of real-time content, in accordance with an embodiment of the present invention. Such a process may be performed, for example, by a fingerprint extractor, such as the fingerprint extractor 214 of FIG. 2, implementing a swap indexing method. Initially, as indicated at block 510, new live audio data is received. Such new audio data can be in the form of an audio sample. At block 512, the new live audio data is aggregated with previously received live audio data corresponding with the same audio content. In some embodiments, the previously received live audio data to aggregate with the new live audio data is predetermined in scope, for instance, a particular number of audio samples, a particular fingerprint size, a particular length of live audio associated with the audio data, or the like. In this way, upon receiving new live audio data for an audio sample, live audio data associated with an oldest audio sample can be deleted or removed, for example, from a buffer or other data store of the fingerprint extractor. At block 514, an audio fingerprint is generated in real-time based on the aggregated new live audio data and the previously received live audio data. Such an audio fingerprint can be generated upon reception of the new live audio data or in accordance with a real-time interval duration (e.g., one second). At block 516, the audio fingerprint is provided to a real-time index builder. For example, upon generating an audio fingerprint, such a fingerprint can be transmitted to a real-time index builder via a network.

Turning to FIG. 6, a flow diagram is provided that illustrates an exemplary method 600 for facilitating recognition of real-time content, in accordance with an embodiment of the present invention. Such a process may be performed, for example, by a real-time index builder, such as the real-time index builder 220 of FIG. 2, implementing a progressive indexing method. Initially, as indicated at block 610, a new audio fingerprint associated with new audio data is received. At block 612, fingerprint data associated with the oldest audio data is discarded or removed from the index. At block 614, the index is modified or generated to include fingerprint data associated with the new fingerprint and to exclude fingerprint data associated with the oldest fingerprint. In this regard, the real-time index including fingerprint data associated with a plurality of fingerprints for live content is modified to remove fingerprint data associated with the earliest received fingerprint and include fingerprint data associated with the most recently received fingerprint.

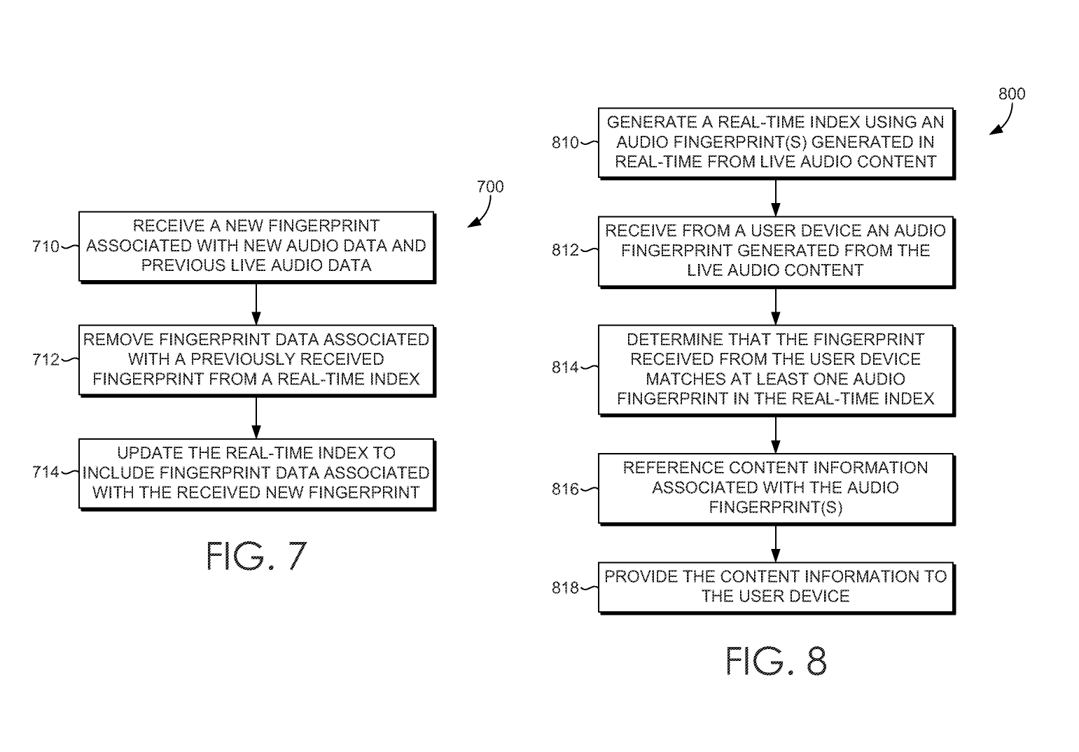

Turning now to FIG. 7, a flow diagram is provided that illustrates an exemplary method 700 for facilitating recognition of real-time content, in accordance with an embodiment of the present invention. Such a process may be performed, for example, by a real-time index builder, such as the real-time index builder 220 of FIG. 2, implementing a swap indexing method. Initially, as indicated at block 710, a new fingerprint associated with new live audio data and previous live audio data is received. At block 712, fingerprint data associated with a previously received fingerprint is removed from a real-time index. In embodiments, the fingerprint data associated with the previously received fingerprint is identified, for example, in accordance with the oldest received fingerprint. At block 714, the real-time index is updated to include fingerprint data associated with the received new fingerprint.

With reference to FIG. 8, a flow diagram is provided that illustrates an exemplary method 800 for facilitating recognition of real-time content, in accordance with an embodiment of the present invention. Such a process may be performed, for example, by an audio recognition service 216 of FIG. 2. Initially, as indicated at block 810, a real-time index is generated using an audio fingerprint(s) that is generated in real-time from live audio content. At block 812, an audio fingerprint is received from a user device. Such an audio fingerprint is generated from the live audio content via the user device. Thereafter, a determination is made that the audio fingerprint received from the user device matches at least one audio fingerprint in the real-time index. This is indicated at block 814. For purposes of this example, the audio fingerprint received matches at least one audio fingerprint. As can be appreciated, however, in some cases, no matches may occur (e.g., low confidence of a match). At block 816, content information associated with the at least one audio fingerprint is referenced. Such content information may be looked up or otherwise referenced or queried. In embodiments, content information may be displayable information, such as text, coupon, advertisement, content data, etc. or may be an actionable item, such as an indication to present or launch a webpage or an application. Such content information is provided to the user device, as indicated at block 818.

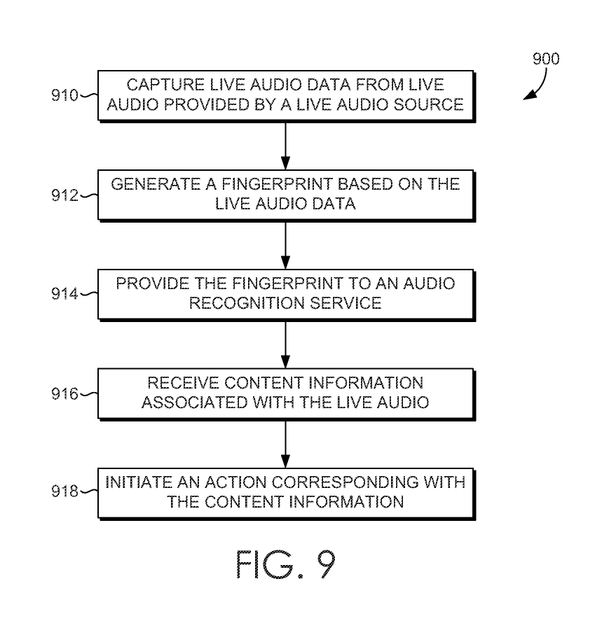

With reference to FIG. 9, a flow diagram is provided that illustrates an exemplary method 900 for facilitating recognition of real-time content, in accordance with an embodiment of the present invention. Such a process may be performed by a user device, such as, for example, user device 218 of FIG. 2. Initially, as indicated at block 910, live audio data is captured from live audio provided by a live audio source. At block 912, a fingerprint is generated based on the live audio data. Fingerprints can be generated automatically (e.g., using background listening) or based on a user indication (e.g., a user selection to identify content). Such a fingerprint is provided to an audio recognition service, as indicated at block 914. Subsequently, at block, 916, content information associated with the live audio data is received. Such content information may be based on a comparison of the fingerprint generated at the user device with one or more fingerprints stored in association with a real-time index that were generated in real-time by a component separate from the user device. At block 918, initiation of an action associated with content information occurs. For example, displayable content information, such a content data, a coupon, an advertisement, can be caused to be displayed. In another example, presentation of a web page or launch of an application may be initiated.

As can be understood, embodiments of the present invention provide systems and methods for facilitating recognition of real-time audio content. The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the method 300 of FIG. 3, method 400 of FIG. 4, method 500 of FIG. 5, method 600 of FIG. 6, method 700 of FIG. 7, method 800 of FIG. 8, and method 900 of FIG. 9 are not meant to limit the scope of embodiments of the present invention in any way and, in fact, the steps may occur in a variety of different sequences within embodiments hereof and may include less or more steps than those illustrated herein. Any and all such variations, and any combination thereof, are contemplated to be within the scope of embodiments of the present invention.

What is claimed is:

1. One or more computer-readable storage media storing computer-useable instructions that, when used by one or more computing devices, cause the one or more computing devices to perform a method for facilitating recognition of real-time content, the method comprising:
receiving a new audio fingerprint associated with live audio being presented;
removing at least one previously received fingerprint associated with the live audio from a real-time index; and
updating the real-time index to include the new audio fingerprint associated with the live audio being presented, wherein the real-time index having the new audio fingerprint is used to recognize the live audio being presented.

2. The one or more computer-readable storage media of claim 1, wherein the new audio fingerprint is received from a fingerprint extractor that generates the new audio fingerprint in real-time as the live audio is presented.

3. The one or more computer-readable storage media of claim 1, wherein the new audio fingerprint corresponds with a single audio sample corresponding with the live audio being presented.

4. The one or more computer-readable storage media of claim 3 further comprising identifying the at least one previously received fingerprint associated with the live audio to remove from among a plurality of previously received fingerprints associated with the live audio, wherein the at least one previously received fingerprint comprises an oldest audio fingerprint corresponding with an oldest audio sample.

5. The one or more computer-readable storage media of claim 1, wherein the new audio fingerprint corresponds with a first plurality of audio samples from the live audio being presented.

6. The one or more computer-readable storage media of claim 5, wherein the at least one previously received fingerprint comprises a single audio fingerprint corresponding with a second plurality of audio samples from the live audio being presented.

7. The one or more computer-readable storage media of claim 6, wherein the first plurality of audio samples and the second plurality of audio samples have a portion of audio samples that are the same.

8. The one or more computer-readable storage media of claim 1, wherein prior to the live audio being presented, an audio fingerprint does not exist for the live audio.

9. The one or more computer-readable storage media of claim 1, wherein the real-time index having the new audio fingerprint is used to recognize the live audio being presented by using the real-time index to match fingerprint data received by a user device with the new audio fingerprint.

10. A system for facilitating recognition of real-time content, the system comprising:
a real-time index builder configured to generate an index in real-time using one or more audio fingerprints generated in real-time from live audio content; and
an audio content recognizer configured to
receive, from a user device, an audio fingerprint generated based on the live audio content, and
utilize the real-time index builder to recognize the live audio content.

11. The system of claim 10, wherein the real-time index builder
receives a first audio fingerprint generated in real-time from the live audio content;
identifies an oldest audio fingerprint from among a plurality of audio fingerprints associated with the live audio content within the real-time index;
removes fingerprint data associated with the oldest audio fingerprint from the real-time index; and
updates the real-time index with fingerprint data associated with the first audio fingerprint.

12. The system of claim 10, wherein the real-time index
receives a first audio fingerprint generated in real-time from the live audio content, the first audio fingerprint being associated with a first plurality of audio samples;
removes fingerprint data associated with a second audio fingerprint from the real-time index, the second audio fingerprint being associated with a second plurality of audio samples; and
updates the real-time index with fingerprint data associated with the first audio fingerprint.

13. The system of claim 10, wherein the live audio content is recognized by comparing fingerprint data associated with the audio fingerprint received from the user device with the fingerprint data associated with the one or more audio fingerprints in the real-time index.

14. The system of claim 13, wherein the live audio content is recognized when the fingerprint data associated with the audio fingerprint received from the user device substantially matches fingerprint data associated with the one of the audio fingerprints in the real-time index.

15. The system of claim 10, wherein the audio content recognizer is configured to reference content information associated with the recognized live audio content.

16. The system of claim 15, wherein the audio content recognizer is configured to provide the content information to the user device.

17. The system of claim 16, wherein the content information comprises displayable information identifying the content or an executable item to indicate an action to execute at the user device.

18. One or more computer-readable storage media storing computer-useable instructions that, when used by one or more computing devices, cause the one or more computing devices to perform a method for facilitating recognition of real-time content, the method comprising:
generating, using a user device, an audio fingerprint based on live audio being provided by a live audio source;
providing the audio fingerprint to an audio recognition service having a real-time index that is updated in real-time to include at least one fingerprint corresponding with the live audio, the at least one fingerprint being generated in real-time by a component remote from the user device;
receiving displayable content information from the audio recognition service based on a comparison of the user-device generated audio fingerprint and the at least one fingerprint generated in real-time by the component remote from the user device; and
causing display of the displayable content information.

19. The computer-readable storage media of claim 18, wherein the displayable content information comprises one or more of a song title, an artist, an album title, a date, a writer, a producer, or group members.

20. The computer-readable storage media of claim 18 further comprising capturing live audio data for use in generating the audio fingerprint.
